(19) United States
(12) Patent Application Publication
(10) Pub. No.: US 2006/0046832 A1
(43) Pub. Date: Mar. 2, 2006

(54) Gaming machine suddenly shifting to a special play mode

(75) Inventors: Ryo Isogai, Tokyo (JP); Takehisa Itagaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corporation, Tokyo (JP)

(21) Appl. No.: 11/209,729

(22) Filed: Aug. 24, 2005

(30) Foreign Application Priority Data
Aug. 26, 2004 (JP) 2004-247176

(51) Int. Cl. A63F 13/00

(52) U.S. Cl. 463/20

(57) ABSTRACT

A gaming machine for starting a bonus game to make it beneficial to the player to acquire coins or the like, so that the player may not feel monotonous. The gaming machine comprises a determination device for determining whether or not symbols displayed in a display 3 contain a feature game combination disclosed to the player, to shift the game to a feature game. The determination device shifts the play mode to a mystery feature game, when the displayed symbols do not contain a base winning combination or a feature game combination but contain a mystery feature game combination not disclosed to the player, and in case a predetermined condition is satisfied.

### CROSS-REFERENCE TO THE RELATED APPLICATION(S)

This application is based upon and claims a priority from the prior Japanese Patent Application No. 2004-247176 which was filed on Aug. 26, 2004 and the entire contents of which are incorporated herein by reference.

### BACKGROUND OF THE INVENTION

1. Field of the Invention

The present invention relates to a gaming machine and, more particularly, to a gaming machine cap-able of making the player feel that the shift to a special play mode beneficial for the player might suddenly occur.

2. Description of the Related Art

A variety of slot machines have been developed/manufactured as a gaming machine for paying back media (as will be called the “coins”) to be used in the game, such as medals or coins in accordance with the contents of a winning combination of the game. The slot machine is installed on a parlor, casino or game arcade so that the slot machine is serviced for the player or the play of the player.

As the slot machine or a kind of gaming machine, there has been developed not only one configured to include a plurality of reels (i.e., mechanical reels) having symbols attached to their outer circumferences but also another configured to include an image display device such as a liquid crystal display replacing the mechanical reels, for displaying a plurality of reels (of an image type or a video type). A number of these gaming machines have spread over the market.

When the player performs a predetermined operation on the slot machine having those mechanical type reels or image type reels, the individual reels start scrolls so that the symbols arranged in a predetermined sequence are cyclically displayed. When all the reels stop, a predetermined symbol combination or a winning combination informed in advance to the player may lie on the activated line (or the pay line) at that time. Then, coins are paid out according to the winning combination. (as disclosed in Japanese Unexamined Patent Publication No. 2003-180908 (Para [0032], FIG. 1))

### SUMMARY OF THE INVENTION

In the play using the slot machine thus far described, the player is interested only in whether or not the winning combination lies on an activated line, and may feel the play itself monotonous as the play continues.

The present invention contemplates to provide a gaming machine for starting a bonus game or the like to make it beneficial for the player to acquire coins or the like, so that the player may not feel monotonous.

The invention has the following characteristics as means for solving the aforementioned problems.

A first aspect of the invention is proposed as a gaming machine. This gaming machine comprises: a symbol display device (e.g., a display) including a plurality of symbol display units capable of variably displaying a plurality of continuous symbols, for displaying at least one of the plurality of symbols in each of the symbol display units when the variable display is stopped according to a predetermined variable stop condition; and a determination device (e.g., a microcomputer or a main CPU) for determining whether or not the symbols displayed in the individual symbol display units in a stopped variable display state contain a first predetermined symbol combination disclosed to the player, to pay out valuables (e.g., coins) to the player in case the displayed symbols contain the first predetermined symbol combination, and for determining whether or not the symbols displayed in the individual symbol display units in the stopped variable display state contain a second predetermined symbol combination disclosed to the player, to shift the play mode from a base play mode to a first special play mode (e.g., a feature game state) for making the payout of the valuables beneficial to the player, in case the displayed symbols contain the second predetermined symbol combination. The determination device shifts the play mode from the base play mode to a second special play mode (e.g., a mystery feature game state), in which the payout of the valuables beneficial to the player, when the symbols displayed in the individual symbol display units contain neither the first predetermined symbol combination nor the second predetermined symbol combination, in case the symbols displayed in the individual symbol display units contain a third predetermined symbol combination not disclosed to the player, and in case a predetermined condition is satisfied.

The aforementioned word “valuables” implies realizable values or the irrealizable values having some merits, and may be either tangibles such as the medals, coins or chips (as will be generally called the “coins”) to be used in the parlor, game arcade or casino, or intangibles such as credits or the information enumerated from the number of coins.

Herein, the phrase “combination of symbols” is a concept containing not only a plurality of symbols but also one specific symbol. The concept of “symbol combination” may specify the sequence of symbols arrayed or may not.

The phrase “disclosed to the player” is to provide the player with the fixed information. For example, this information is so displayed in the panel or display of the gaming machine as can be recognized by the player. The player is informed by the person (e.g., the developer, manufacturer or seller of the gaming machine) having a lawful right to know the information stored in the gaming machine, such as the determination logic owned by the determination means of the gaming machine, or by the person (e.g., the owner or manager of the parlor, game arcade or casino where the gaming machine is installed) granted to know the information.

The information acquired not on the basis of the information disclosed to the player, such as the information recognized empirically by repeating the plays of the player, or the information obtained orally from the player or taught through information media such as magazines or internet is not contained in the information “disclosed to the player”.

According to the mode of the invention, the player can enjoy the special play mode, in which the payout to the player is made beneficial, even when the third predetermined symbol combination not disclosed to the player is made. The player does not know what symbol the special play mode is started on, and feels as if the special play mode were suddenly started. As a result, the player can enjoy the play without feeling monotonous for the play.

The second mode of the invention is proposed as a gaming machine. This gaming machine comprises: a symbol display device (e.g., a display) including a plurality of symbol display units capable of variably displaying a plurality of continuous symbols, for displaying at least one of the plurality of symbols in each of the symbol display units when the variable display is stopped according to a predetermined variable stop condition; a first determination device (e.g., a CPU) for determining whether or not the symbols displayed in the individual symbol display units in a stopped variable display state contain a first predetermined symbol combination, to pay out valuables (e.g., coins) to the player in case the displayed symbols contain the first predetermined symbol combination, and for determining whether or not the symbols displayed in the individual symbol display units in the stopped variable display state contain a second predetermined symbol combination, to shift the play mode from a base play mode to a first special play mode (e.g., a feature game state) for making the payout of the valuables beneficial to the player, in case the displayed symbols contain the second predetermined symbol combination; and a second determination device (e.g., a CPU) for shifting the play mode from the base play mode to a second special play mode (e.g., a mystery feature game state), in which the payout of the valuables is made beneficial to the player, in response to the satisfaction of a predetermined play mode occurrence condition.

According to the gaming machine of the second mode, independently of the determination of the shift to the first special play mode by the first determination device, the second determination device makes the determination of the shift to the second special play mode. As a result, the shift to the second special play mode can occur independently of the symbols displayed in the state where the variable display for the basis of the determination of the first determination device is stopped. Therefore, the player is made to recognize that the gaming machine suddenly causes the shift to the second special play mode. The player can expect the pleasure of the second special play mode which suddenly occurs so that the player can enjoy the play without feeling monotonous for the play.

According to the first mode of the invention, it is possible to provide a gaming machine, which makes the player feel the special play mode suddenly without knowing what symbol the special play mode is started on, so that the player does not feel monotonous for the play.

According to the second mode of the invention, it is possible to provide a gaming machine, which can keep the interest of the player in the play while giving to the player an expectation to enjoy the sudden second special play mode.

### BRIEF DESCRIPTION OF THE DRAWINGS

FIG. 1 is a perspective view showing the appearance of a slot machine according to an embodiment of the invention;

FIG. 2 is a diagram showing a button arrangement of a control panel;

FIG. 3 is a block diagram showing the slot machine while centering the internal configuration;

FIG. 4 is a block diagram showing one example of the internal configuration of an image control circuit;

FIG. 5 is a diagram showing a display screen of a display;

FIG. 6 is a diagram showing symbols displayed in the display;

FIGS. 7A and 7B are diagrams showing examples of the pay lines of the slot machine;

FIG. 8 is a diagram showing symbol arrays of the slot machine according to the embodiment;

FIG. 9 is a flow chart showing a game progress of the slot machine;

FIG. 10 is a flow chart showing an example of a feature game process;

FIG. 11 is a flow chart showing an example of a free spin process;

FIG. 12 is a flow chart showing an example of a mystery feature game process;

FIG. 13 is a diagram showing an example of the display screen of the display;

FIG. 14 is a diagram showing the display screen of the display subsequent to the screen of FIG. 13;

FIG. 15 is a diagram showing the display screen of the display subsequent to the screen of FIG. 14;

FIG. 16 is a diagram showing the display screen of the display subsequent to the screen of FIG. 15;

FIG. 17 is a diagram showing the display screen of the display subsequent to the screen of FIG. 16; and

FIG. 18 is a diagram showing the display screen of the display subsequent to the screen of FIG. 17.

### DETAILED DESCRIPTION OF THE PREFERRED EMBODIMENTS

The best mode of the invention for carrying out a gaming machine according to the invention will be described in detail with reference to the accompanying drawings. Here, the identical or equivalent components are designated by common reference numerals, and their descriptions are omitted if they overlap each other.

### 1. First Embodiment

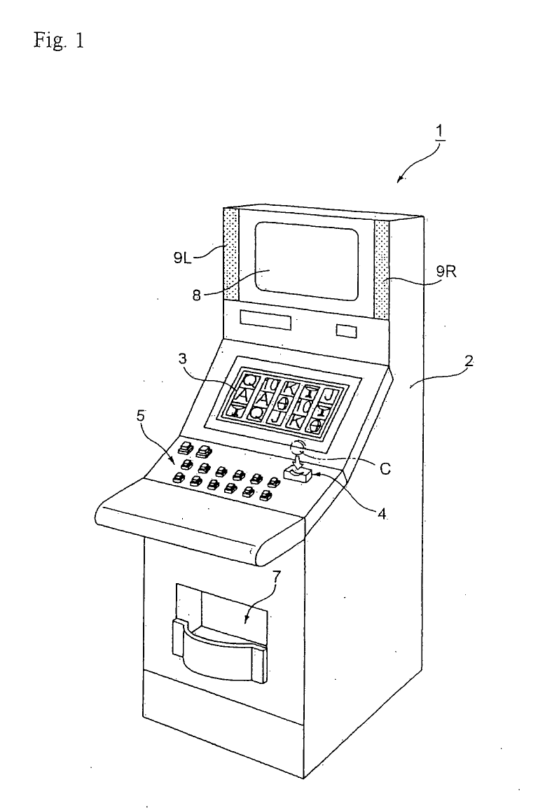

FIG. 1 is an overall perspective view showing a slot machine or a gaming machine according to a first embodiment. The slot machine 1 includes a cabinet 2, which is provided with a display 3 or symbol display means. The display 3 is a liquid crystal display for digitally displaying a slot game, for example. On this side below the display 3, there is disposed a coin insertion slot 4 for inserting coins. Here may also be suitably disposed a paper money insertion slot for playing the slot game with the paper money.

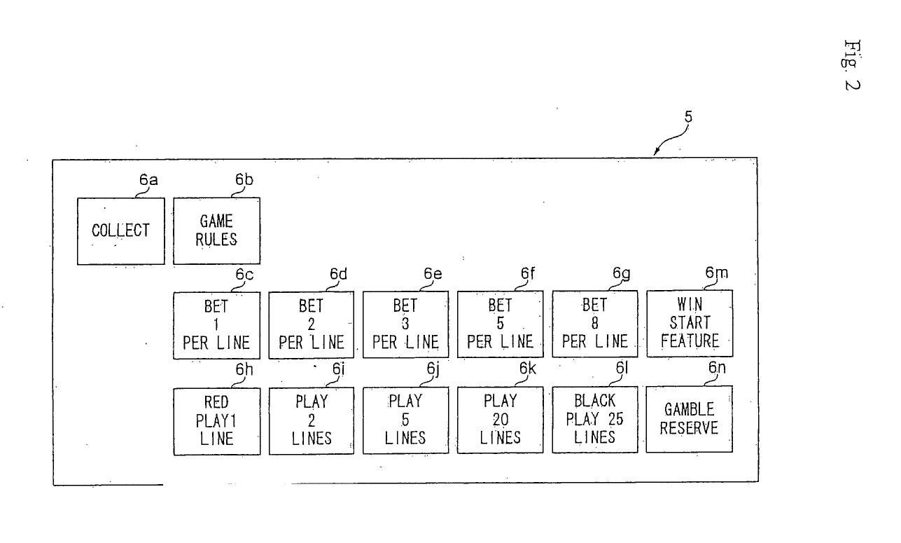

Below the display 3, there is disposed a control panel 5. This control panel 5 is substantially similar to that belonging to the well-known slot game, and is provided with fourteen buttons 6a to 6n, as shown in FIG. 2.

Specifically, the control panel 5 is provided, in the upper portion on the left side, with a collect button (COLLECT) 6a for fixing the coins acquired in the game, and a game rule button (GAME RULES) 6b for instructing execution of a help function. The remaining twelve buttons are arranged in two stages substantially at the center of the control panel 5: five betting buttons 6c to 6g for determining the number of coins bet (i.e., the bet number); five line buttons 6h to 61 for determining the line number; a start feature button (START FEATURE) 6m for a feature game (e.g., a game for plural free spins) or a first special play mode; and a gamble button (GAMBLE) 6n for determining the shift to a double game at the end of the feature game.

Reverting to FIG. 1, the cabinet 2 is provided in its lower portion with a coin tray 7 for the player to receive coins paid out. In FIG. 1, numeral 8 designates a subdisplay for displaying images (e.g., the explanation of game contents or the effects of the feature game) having no direct relation to the game, and numerals 9L and 9R designate a pair of speakers.

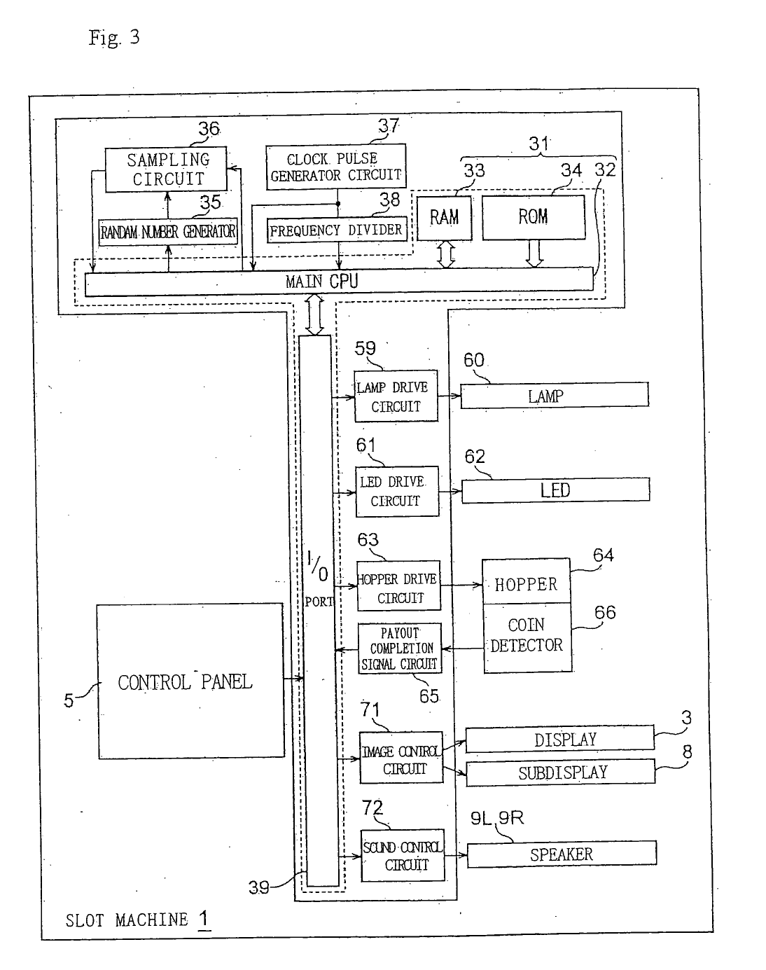

FIG. 3 is a block diagram showing the internal configuration of the slot machine 1. As shown in FIG. 3, the slot machine 1 is provided with a plurality of components around a microcomputer 31.

The microcomputer 31 includes a main CPU (Central Processing Unit) 32, a RAM (Random Access Memory) 33 and a ROM (Read Only Memory) 34.

In accordance with the program stored in the ROM 34, the main CPU 32 functions to input signals from the individual units of the control panel 5 through an I/O port 39 and to input/output signals with other components thereby to control the actions of the entire slot machine 1. The RAM 33 is stored with the data and program to be used for the main CPU 32 to function, and temporarily holds the random number values to be sampled by a later-described sampling circuit 36, for example, after the game starts. The ROM 34 is stored with the program to be executed by the main CPU 32, and the permanent data.

On the other hand, the slot machine 1 is provided with a random number generator 35, the sampling circuit 36, a clock pulse generator 37 and a frequency divider 38. In accordance with an instruction of the main CPU 32, the random number generator 35 functions to generate random numbers within a predetermined range. In accordance with an instruction of the main CPU 32, the sampling circuit 36 extracts arbitrary one from the random numbers generated by the random number generator 35, and inputs the extracted random number to the main CPU 32. The clock pulse generator 37 generates a reference clock to be utilized in the main CPU 32, and the frequency divider 38 inputs a signal, which is prepared by dividing the reference clock with a predetermined period, to the main CPU 32.

The slot machine 1 is further provided with a lamp drive circuit 59, a lamp 60, an LED drive circuit 61, an LED 62, a hopper drive circuit 63, a hopper 64, a payout completion signal circuit 65 and a coin detector 66. The slot machine 1 is further provided with an image control circuit 71 for controlling images to be displayed in the display 3 and the subdisplay 8, and a sound control circuit 72 for controlling the sound to be generated from the speakers 9L and 9R.

The lamp drive circuit 59 outputs a signal to the lamp 60 to turn the lamp 60 on, and turns on/off the lamp 60 during executing the game. This turning-on/off effects the game. The LED drive circuit 61 controls the flashing display of the LED 62. This LED 62 indicates the credit number, the acquisition number and so on.

In accordance with the control of the main CPU 32, the hopper drive circuit 63 drives the hopper 64, which acts to pay out the valuables or coins from the coin tray 7.

The coin detector 66 measures the number of coins paid out by the hopper 64 and informs the payout completion signal circuit 65 of the data of the measured number. The payout completion signal circuit 65 inputs the data of coin number from the coin detector 66, and inputs a signal informing the coin payout completion to the main CPU 32 when the coin number reaches the data of set number.

The image control circuit 71 controls the individual image displays in the display 3 and the subdisplay 8 so that the various images such as the later-described symbol images may be displayed by the display 3 and the subdisplay 8.

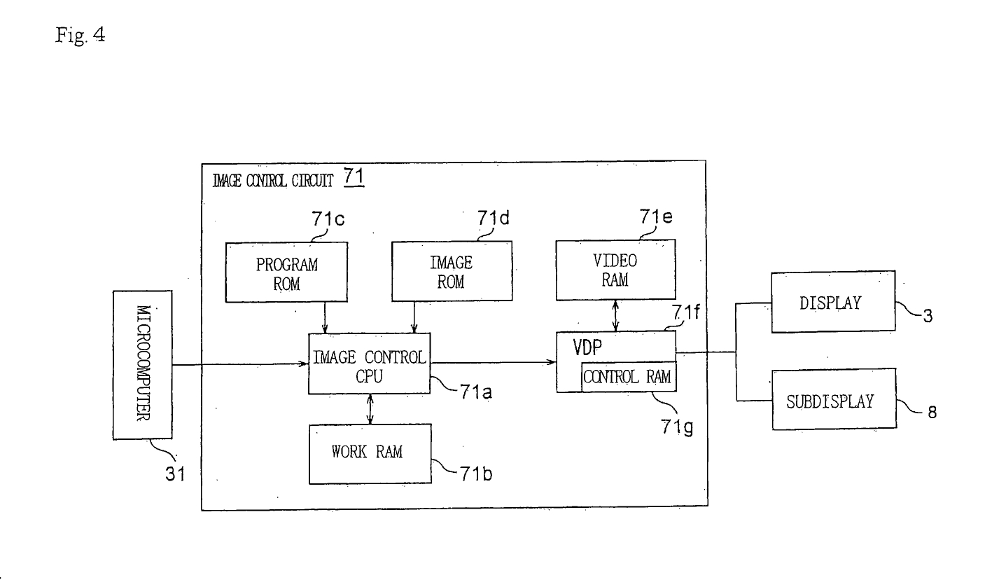

This image control circuit 71 is provided, as shown in FIG. 4, with an image control CPU 71a, a work RAM 71b, a program ROM 71c, an image ROM 71d, a video RAM 71e and a VDP (Video Display Processor) 71f. On the basis of parameters set by the microcomputer 31 and in accordance with the image control program prestored in the program ROM 71c, the image control CPU 71a determines the images (e.g., the symbol images) to be displayed in the display 3 and the subdisplay 8. The work RAM 71b is configured as temporary storage means for the image control CPU 71a to execute the image control program.

The program ROM 71c is stored with the image control program or the various selection tables. The image ROM 71d is stored with dot data for forming the images. In this embodiment, these dot data contain the data of the various symbol images (as will be called the “symbol image group”). The video RAM 71e is configured as temporary storage means for the VDP 71f to form the images. The VDP 71f has a control RAM 71g, and forms the images, which are determined by the image control CPU 71a and which accord to the display contents of the display 3 and the subdisplay 8, and outputs the individual images formed, to the display 3 and the subdisplay 8.

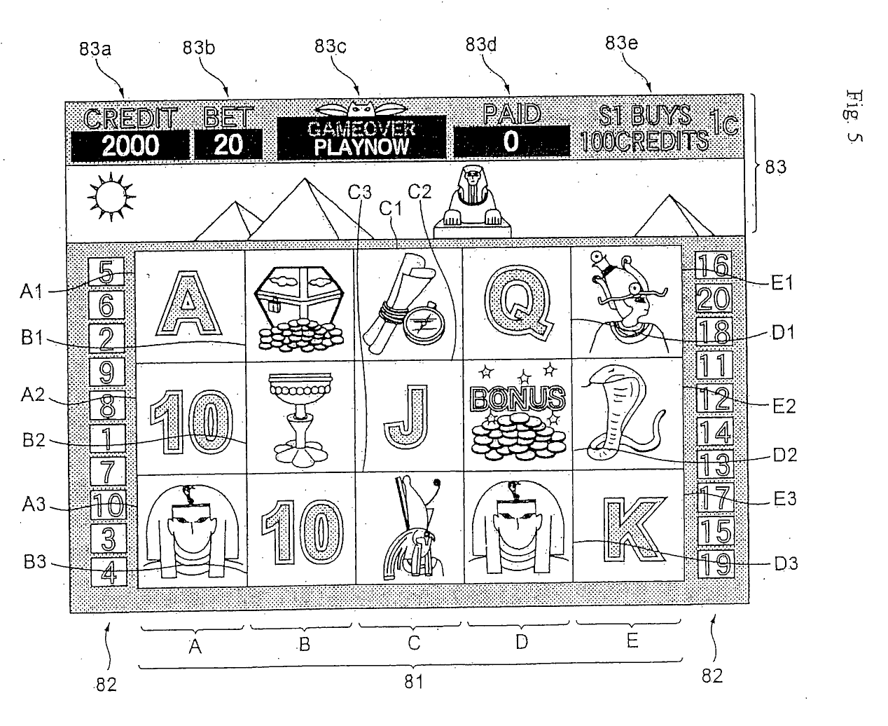

FIG. 5 is a diagram showing a display screen example of the display 3 or the symbol display means. In this embodiment, a display area unit 81, line number display area units 82 and an upper display area unit 83 are displayed in the display 3.

The display area unit 81 is provided with (five, in this example) display areas A to E or symbol display units each for displaying (e.g., three) symbols. In these display areas A to E, there are so variably displayed the reel images having symbols of a plurality of kinds that they may rotate. The symbols, which are selected when the individual reel images stop, are processed so that they may be displayed one by one in the individual symbol display areas A1 to A3, B1 to B3, C1 to C3, D1 to D3, and E1 to E3.

On the two sides of the display area unit 81, there are displayed the line number display units 82, which display the line numbers indicating the individual pay lines or the activated lines. Of the line numbers displayed in the line number display units 82, the numbers corresponding to the pay line or the activated line selected by the player are turned on, but the numbers left unselected by the player are turned off.

Over the display area unit 81, there is formed the upper display area unit 83. This upper display unit 83 is composed of a credit number display area 83a, a BET number display area 83b, a letter information display area 83c, a PAID number display area 83d and a fare display area 83e. Here, the credit number display area 83a displays the number of coins being credited, and the BET number display area 83b displays the number of coins bet for one game. Moreover, the letter information display area 83c displays letter information indicating the current state of the game, such as the letter information of the feature game state, when this state comes in. Still moreover, the PAID display area 83d displays the number of coins acquired in one game, and the fare display area 83e displays the CREDIT.

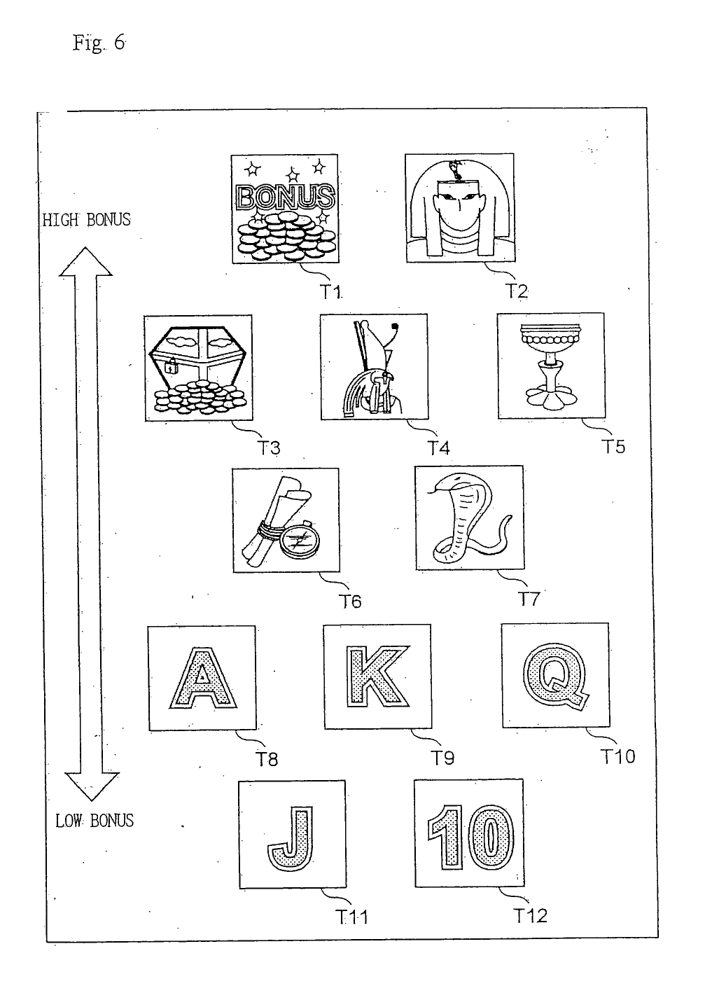

FIG. 6 enumerates the symbols to be displayed in the individual display areas A to E (i.e., the individual symbol display areas A1 to A3, B1 to B3, C1 to C3, D1 to D3, and E1 to E3). The symbols in this embodiment are exemplified: by special symbols, e.g., a bonus symbol T1 and a wild symbol T2; and by base symbols such as a treasure symbol T3, a mask symbol T4, a chalice symbol T5, a map symbol. T6, a snake symbol T7, and five kinds of card mark symbols T8 to T12.

The bonus symbol T1 of the special symbol is a symbol (or a scatter symbol) for triggering the rush into the feature game or a second predetermined symbol combination. For example, the game shifts to the feature game, in case a predetermined number of (e.g., four or more) bonus symbols T1 are displayed in the display areas A to E. In this embodiment, the shift to the feature game occurs, if the bonus symbols T1 are displayed in the predetermined number in the display areas A to E no matter where and how they might be displayed or arranged.

On the other hand, the wild symbol T2 or another special symbol is treated as any of the base symbols, that is, the aforementioned treasure symbol T3, mark symbol T4, chalice symbol T5, map symbol T6 and snake symbol T7, and the card mark symbols T8 to T12 of the five kinds. In short, the wild symbol T2 is the so-called “almighty symbol” and can be an element of the combination of the second predetermined symbol combination.

The card mark symbols are the five kinds of the ace symbol (“A”) T8, the king symbol (“K”) T9, the queen symbol (“Q”) T10, the jack symbol (“J”) T1 and the numeral symbol (“10”) T12.

Moreover, the object for the slot machine 1 to display in the symbol display area may also include a blank symbol. This blank symbol may be treated as one kind of symbol to display nothing in the symbol display area, or may be treated as one to be ignored in the determination of a win or a shift to a special game because no symbol exists. The invention can also treat this blank symbol as included in the “symbol”.

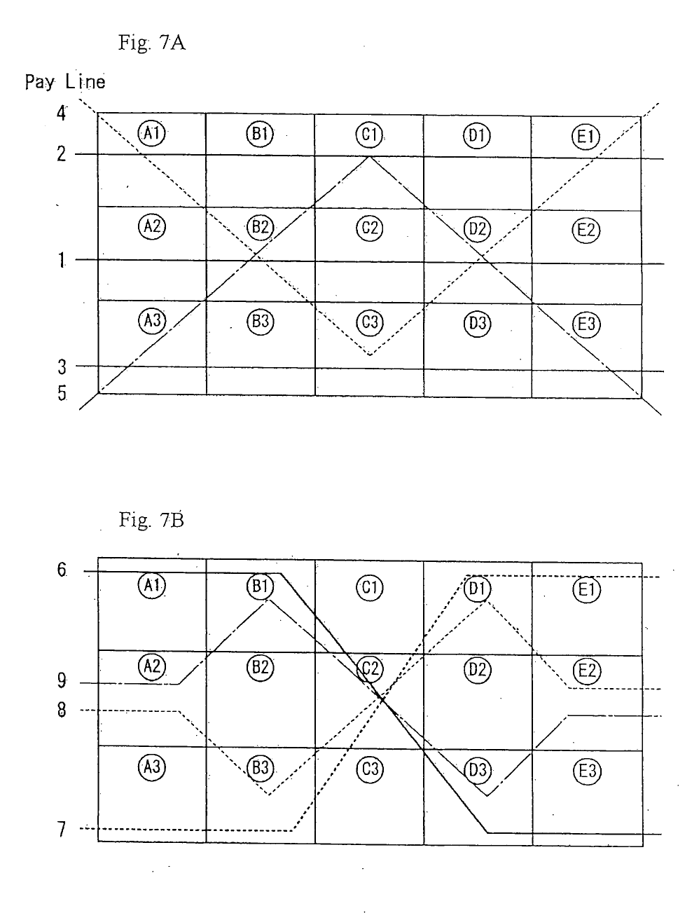

FIG. 7A and FIG. 7B are diagrams showing an example of the pay lines of the slot machine 1. For easy understanding, the pay lines are divided into the two diagrams For example, nine pay lines are prepared, as shown in the individual diagrams. When a winning combination of symbols or the first predetermined symbol combination is arrayed in any of those pay lines, the bonus corresponding to the contents of the winning symbol combination is paid to the player.

Other eleven pay lines are prepared, although not shown, so that twenty pay lines are prepared in total. Thus, in this embodiment, the display areas corresponding to reels are prepared in rows as many as five, so that various pay lines can be provided.

The win is decided depending upon whether or not a combination of arrayed identical symbols or one example of the first predetermined symbol combination is on such one of the twenty pay lines set in the symbol display areas A1 to A3, B1 to B3, C1 to C3, D1 to D3, and E1 to E3 as designated with the line buttons 6h to 61 by the player. If the combination of identical symbols is aligned on the pay line designated by the player, the main CPU 32 or the determination means decides that the winning condition is satisfied, and causes the payout of a predetermined number of coins.

In this win determination, the wild symbol T2 is decided as the almighty symbol and is treated as a beneficial one for the payout (e.g., the number of coins paid for one coin) in the symbols of the aforementioned ten kinds. Even if the ace symbols T8 and the wild symbols T2 are exclusively arranged in all the symbol display areas of one pay line, the number of coins paid is identical to that of the case, in which the ace symbols T8 are arranged in all the symbol display areas on one pay line. In this case, the wild symbols T2 are treated as the ace symbols T8 on that pay line.

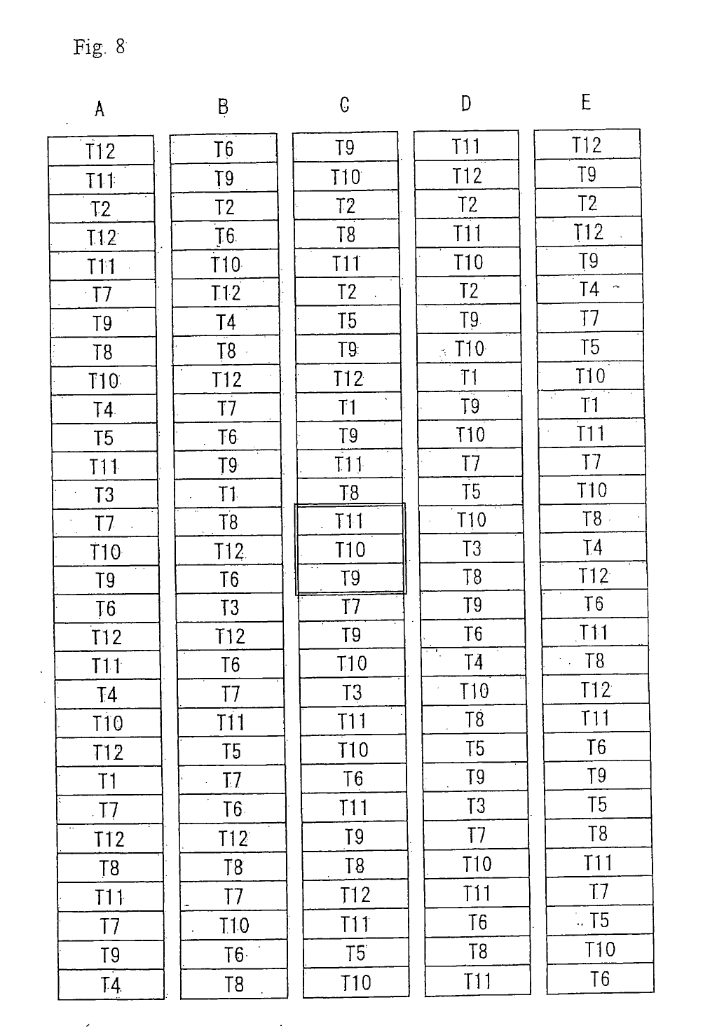

Next, the array of the symbols displayed in the individual display areas A to E is described with reference to FIG. 8. As shown in FIG. 8, thirty symbols arranged in a predetermined sequence are displayed cyclically and variably displayed in the individual display areas A to E. In this embodiment, the scroll display is adopted as the variable display, but this variable display may use a display method other than the scroll display.

By this scroll display, the player is enabled to recognize the symbols as if the mechanical reels were rotated to vary the symbols. The individual display areas A to E may display the symbols by scrolling them for equal periods or for different periods.

For the slot machine 1 according to this embodiment, there are prepared in the progress of the game: a base game state corresponding to the base play mode; the feature game state corresponding to the first special play mode; and the mystery feature game state corresponding to the second special play mode.

The main CPU 32 of the microcomputer 31 or the determination means decides whether or not the feature game occurrence condition is satisfied and whether or not the mystery feature game occurrence condition is satisfied. The feature game is executed, in case the feature game occurrence condition is satisfied, and the mystery feature game is executed in case the mystery feature game occurrence condition is satisfied.

This feature game occurrence condition is that a predetermined number of bonus symbols T1 are displayed in the display areas A to E. Here, the coin paying percentage in the feature game percentage is set higher than that of the coins in the base game state. In short, this feature game state is far more beneficial for the coin payout than the base game state. Therefore, the player plays the base game while expecting the shift to the feature game.

On the other hand, the mystery feature game occurrence condition is exemplified in that a symbol (which may be either the special symbol or the base symbol) other than the bonus symbol is displayed in the display areas A to E while the base win is not satisfied. This mystery feature game occurrence condition may be so programmed in the microcomputer 31 as is satisfied in the base game state, may be so programmed in the microcomputer 31 as is satisfied in both the base game state and the feature game state, or may be programmed in the microcomputer 31 or the determination means as is satisfied only in the feature game state.

Here, the payout of coins in the mystery feature game state is preferably set more beneficial (e.g., higher in the possibility to acquire the coins and/or more in the average number of acquired coins) than that in the base game state. In short, this mystery feature game state is more beneficial for the payout of coins than the base game state. Therefore, the player is ordinarily playing the game while expecting the shift to the mystery feature game. Here, it is arbitrary that the designer or manager of the gaming machine suitably decides whether or not the payout of coins in the mystery feature game state is made more beneficial than that in the feature game state.

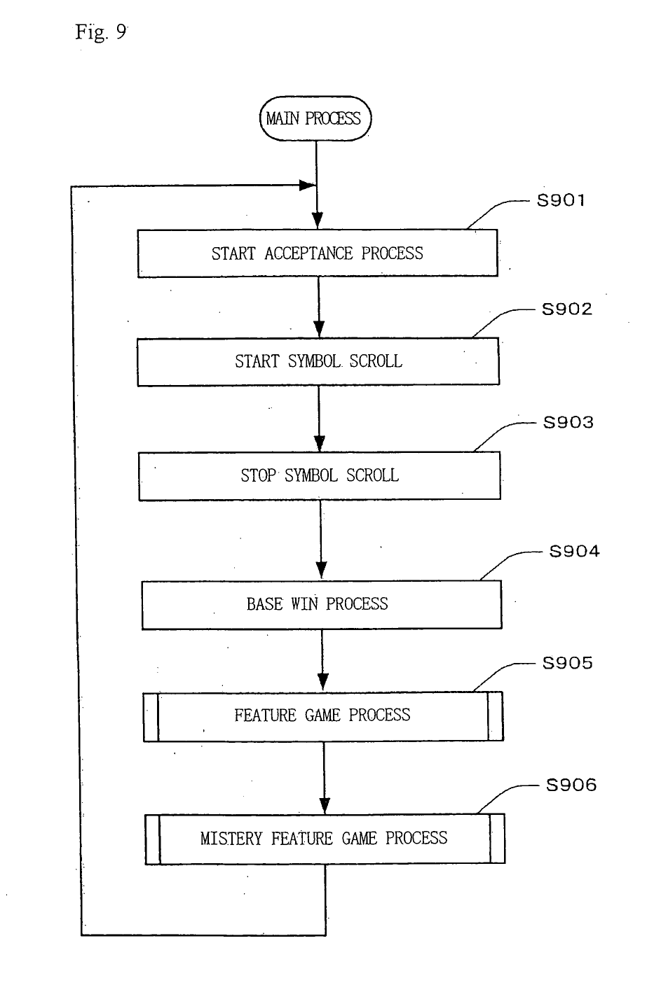

Here is described a method for controlling the slot machine 1 according to this embodiment. FIG. 9 is a flow chart showing one example of the actions of the slot machine 1.

When the main process is started, the slot machine 1 at first executes a start acceptance process (at S901) for starting the game. Specifically, the main CPU 32 accesses to the ROM 34. The ROM 34 transfers the information on the fundamental screen such as the frame to be displayed in the display 3, to the image control circuit 71, and this image control circuit 71 once stores the received information in the video RAM 71e and displays the information in the display 3. As a result, the player can play the slot game serviced by the slot machine 1.

The succeeding routine is realized such that the main CPU 32 executes the programs stored in the ROM 34 and the RAM 33. Here, the slot machine 1 is caused, when started by turning on the main switch, to execute the base game as the slot game.

At this Step S901, the slot machine 1 awaits the BET operation (e.g., to insert coins or to push the bet button) of the player. Specifically, the slot machine 1 starts the base game when coins of a number to be bet for one game are inserted into the coin insertion slot 6 or when the betting buttons 6c to 6g are pushed with the credits being stored in the slot machine 1. When the base game is started, the symbols displayed in the individual display areas A to E are scrolled (at Step S902). At this time, the main CPU 32 controls the image control circuit 71 to execute the image processing as if the mechanical reels were rotating. Moreover, the main CPU 32 makes use of the random number values sent from the sampling circuit 36 to determine the symbols to be displayed in the individual symbol display areas A1 to A3, B1 to B3, C1 to C3, D1 to D3, and E1 to E3 after the variable displays were stopped, and stops the scroll display and shifts it to the variable stop state. After the shift to the variable stop state, the display 3 performs the symbol scroll stop (at Step S903) to display the determined symbol in the corresponding symbol display area.

After the symbol scroll stop (at Step S903), the main CPU 32 execute the base win process (at Step S904). Specifically, the main CPU 32 decides whether or not the symbols displayed in the symbol display areas in the stop display state are in the predetermined symbol combination or the base winning combination on at least one activated line. In case the displayed symbols are in the predetermined symbol combination or the base winning combination, the main CPU 32 either pays out the coins in the number corresponding to the base winning combination or adds the value of the credits corresponding to that base winning combination, to the inserted or acquired credit value stored in the slot machine 1.

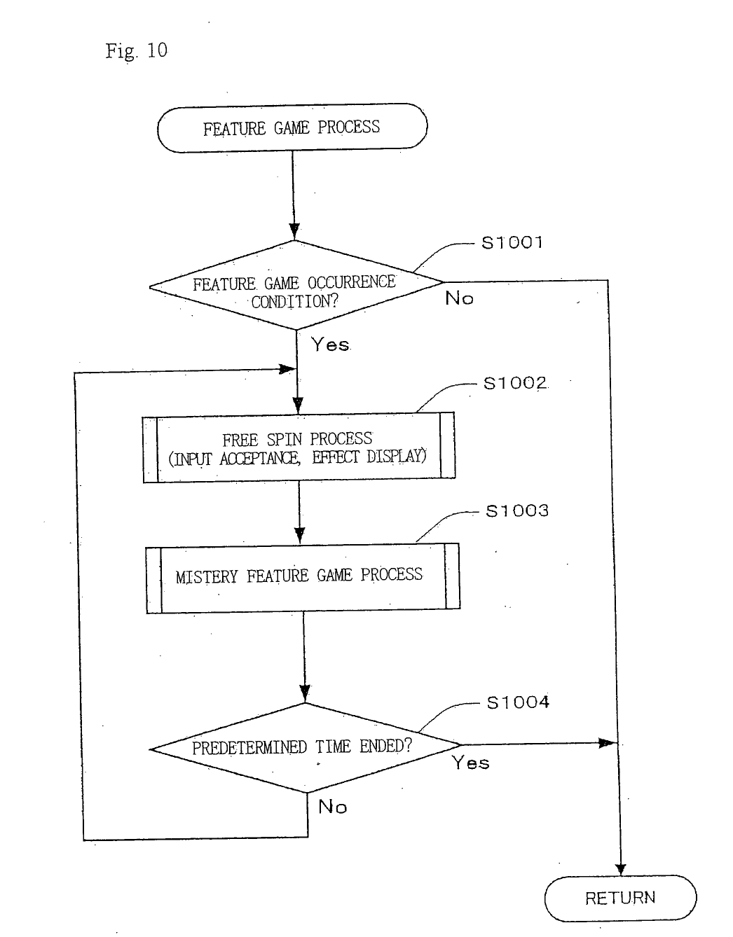

Subsequent to the base win process (at Step S9b4) the main CPU 32 executes a feature game process (at Step S905). FIG. 10 presents a flow chart showing one example of the feature game process. An example of the feature game process is described with reference to FIG. 10.

When the process is shifted to the feature game process, the main CPU 32 or the determination means decided (at Step S1001) whether or not the feature game occurrence condition is satisfied. In this determination, the main CPU 32 decides it as a satisfaction of the feature game occurrence condition that the second predetermined symbol combination is displayed in the individual display areas A to E of the display 3, specifically, in the individual symbol display areas A1 to A3, B1 to B3, C1 to C3, D1 to D3, and E1 to E3, e.g., that four or more bonus symbols T1 are displayed. In case the number of the bonus symbols T1 is three or less, on the contrary, it is decided that the condition for the feature game occurrence is dissatisfied.

In case the main CPU 32 decided the dissatisfaction of the feature game occurrence condition (that the answer of Step S1001 is No), the main CPU 32 ends the feature game process and returns the control to the main process (of FIG. 9).

In case, on the contrary, the main CPU 32 decided the satisfaction of the feature game occurrence condition (that the answer of Step S1001 is Yes), the main CPU 32 shifts the game state from the base game state to the feature game state. The slot machine 1 shifted to the feature game state performs ten free spins. In this embodiment, the feature game is a service of ten free spins.

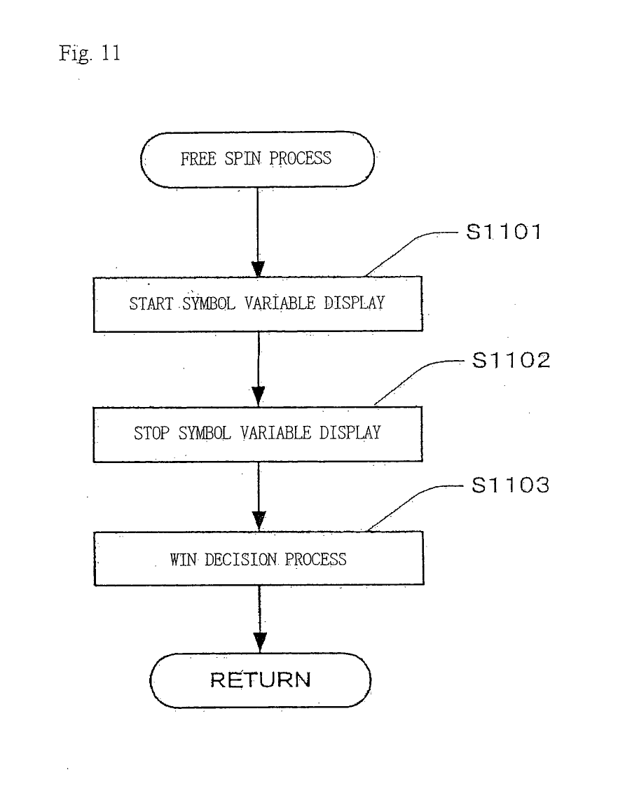

FIG. 11 shows one example of the free spin process (of Step S1002). One example of the free spin process (of Step S1002) is described with reference to FIG. 11.

When the free spin process (of Step S1002) is started, the main CPU 32 executes, in response to a predetermined operation of the player, a symbol variable display start (at Step S1101) or a process similar to the symbol scroll start (at Step S902). This symbol variable display start needs neither the insertion of coins nor the push of the betting buttons 6c to 6g. In other words, the player is given a change to acquire the coins without consuming the coins or the stored credits.

Subsequently, the main CPU 32 executes a symbol variable display stop (of Step S1102) like the aforementioned symbol scroll stop (of Step S903). In the process of the symbol variable display stop (at Step S1102), the main CPU 32 determines the symbols displayed in the individual display areas A to E in the state exhibiting the variable displays, and displays the determined symbols (as called the “stop symbols”) individually in the display areas A to E.

In case the stop symbols displayed in the individual display areas A to E contain a predetermined symbol combination (e.g., the base winning combination), the main CPU 32 then calculates either the number of coins to be paid to the player or the credit number to be newly added to the owned one of the player in accordance with the combination, and executes a win determination process (at Step S1103) to instruct the hopper drive circuit 63 to eject the coins of the calculated number or to add the credit value.

When the processes from Step S1101 to Step S1103 are executed, one free spin is ended. Finishing the description of the free spin process (of Step S1002), the description is returned to the feature game process (of FIG. 10).

When the aforementioned free spin process (of Step S1002) is ended, the main CPU 32 executes the mystery feature game process (at Step S1003). The main CPU32 starts the mystery feature game process, in case the symbol stopped at the ending time of each free spin satisfies the mystery feature game occurrence condition. The specific contents of the mystery feature game will be described later in detail. In this embodiment, the shift to the mystery feature game occurs in the feature game, too. However, the invention should not be limited to such construction, but can also be constructed as a gaming machine, in which the shift to the mystery feature game does not occur during the feature game.

Subsequently, the main CPU 32 decides (at Step S1004) whether or not the free spins have been executed a predetermined number of times (ten in the example of this embodiment) for ending the feature game. In case the free spins are executed the predetermined number of times (that is, the answer of Step S1004 is Yes), the feature game process is ended, and the control is returned to the main process (of FIG. 9) In case the free spins are not executed the predetermined number of times (that is, the answer of Step S1004 is No), the main CPU 32 returns to the process of Step S1002 and continues the feature game process. Specifically, the main CPU 32 repeats the processes from Step S1002 to Step S1004.

The description on the feature game process is thus ended and is returned to the main process (of FIG. 9).

When the feature game process (of Step S905) is ended in the main process, the main CPU 32 starts the mystery feature game process (at Step S906). Here is described the mystery feature game in the base game state. However, the mystery feature game process in the feature game state has identical game contents.

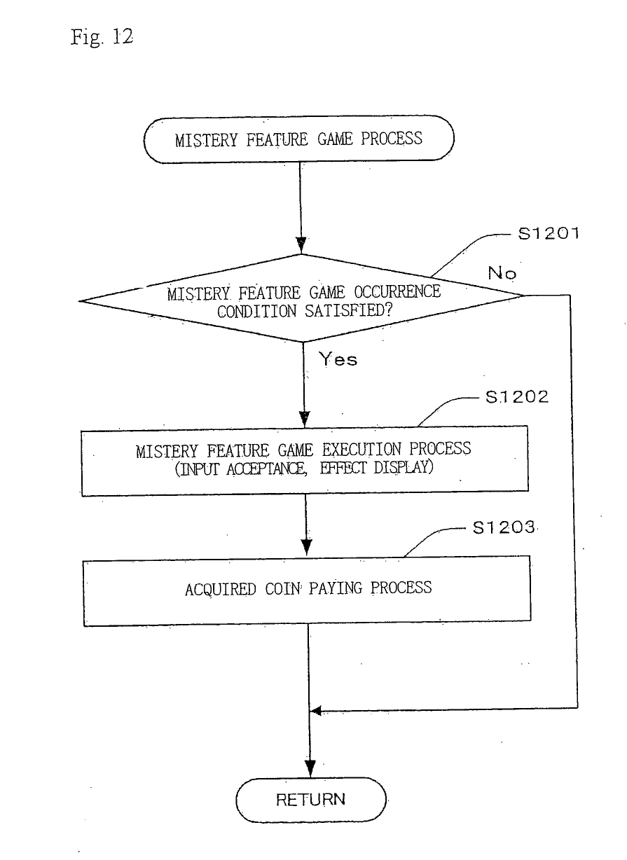

FIG. 12 presents a flow chart showing one example of the mystery feature game process. This example of the mystery feature game process is described with reference to FIG. 12.

When the mystery feature game process is started, the main CPU 32 determines whether or not the mystery feature game occurrence condition is satisfied (at Step S1201) on the basis of the symbols displayed in the display areas in the variable display stopped state.

The conditions for the mystery feature game occurrence may be set with the feature game occurrence conditions or ordinary various ones, as exemplified by the following several ones.

(1) The condition that a specific symbol other than the bonus symbol T1 is displayed in at least one of the display areas A to E.

This mystery feature game occurrence condition (1) may be specifically exemplified, for example, by that the snake symbol T7 other than the bonus symbol T1 is displayed in an arbitrary symbol display area, or that the snake symbol T7 is displayed in a specific symbol display area (e.g., the symbol display area E1).

(2) The condition that a combination of symbols including a specific symbol other than the bonus symbol T1 is displayed in the display areas A to E.

This mystery feature game occurrence condition (2) may be specifically exemplified, for example, by that the ace symbol T8, the card mark symbol “10”, the card mark symbol “A”, the card mark symbol “J” and: the snake symbol T7 are displayed in combination sequentially from the left on the pay line. At this time, the pay line may be either effective or ineffective.

(3) The symbol combination other than the winning symbol combination disclosed to the player.

This mystery feature game occurrence condition (3) may be specifically exemplified, for example, by a symbol combination other than the combination of identical symbols of a predetermined number, such as a symbol combination of two ace symbols T8 and one chalice symbol T5 (although their sequence is arbitrary), in case the winning symbol combination is a combination of identical symbols of the predetermined number on the activated line.

On the basis of the mystery feature game occurrence conditions described above, the main CPU 32 decides the satisfaction/dissatisfaction of the mystery feature game occurrence condition from the symbols displayed in the individual display areas A to E of the display 3, that is, the symbols displayed in the individual symbol display areas A1 to A3, B1 to B3, C1 to C3, D1 to D3, and E1 to E3.

In case the main CPU 32 decides in the determination of Step S1201 that the mystery feature game occurrence condition is dissatisfied (i.e., the answer of Step S1201 is No), the main CPU 32 ends the mystery feature game process, and returns the control to the main process (of FIG. 9) without executing the mystery feature game.

In case, on the contrary, the main CPU 32 decides in the determination of Step S1201 that the mystery feature game occurrence condition is satisfied (i.e., the answer of Step S1201 is Yes), the main CPU 32 shifts the game state of the slot machine 1 to the mystery feature game state. In short, the main CPU 32 starts the mystery feature game execution process (of Step S1202).

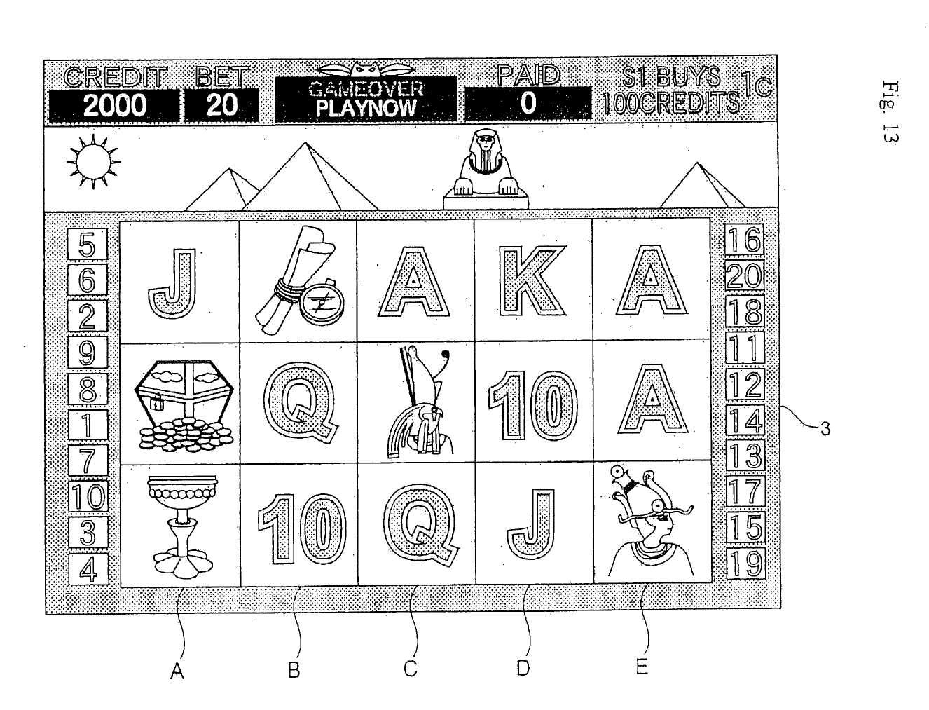

Here is described an example of the mystery feature game execution process with reference to FIG. 13 to FIG. 18. In this description, the mystery feature game occurrence condition in the example shown in FIG. 13 to FIG. 18 is that the display of the snake symbol T7 is displayed in the symbol display area E1.

FIG. 13 is a diagram showing a screen example displayed in the display 3, and shows that the base game or the free spin has been ended so that the variable display of symbols is stopped. At this time, the symbols determined by the main CPU 32 are displayed in the individual symbol display areas A1 to A3, B1 to B3, C1 to C3, D1 to D3, and E1 to E3. In the case of this example, the mystery feature game occurrence condition is not satisfied.

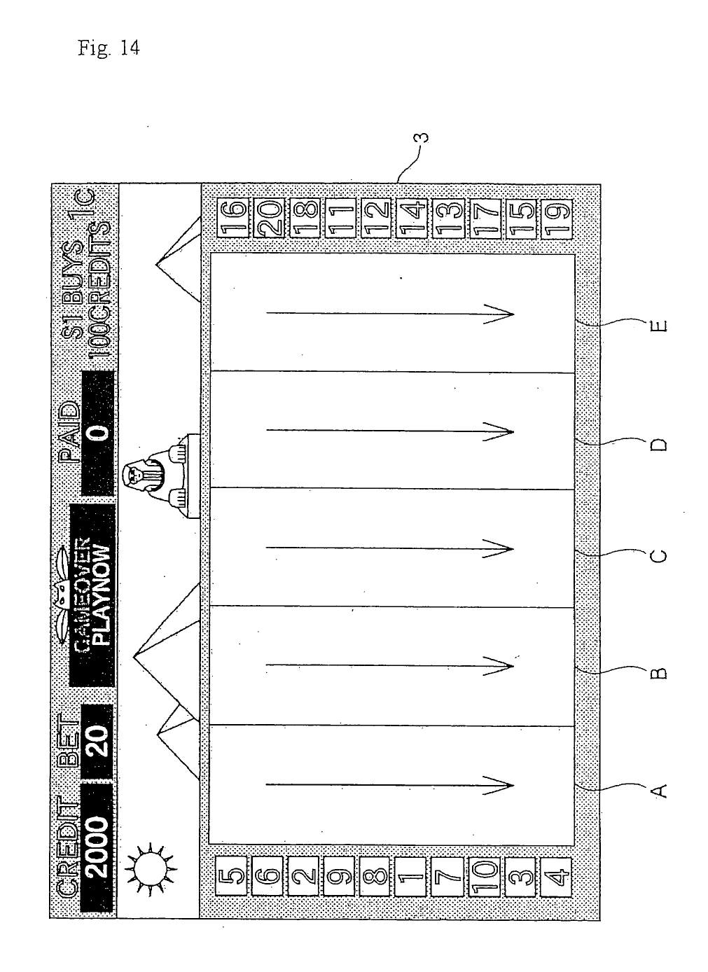

It is assumed that the player performs the base game or the free spin from the state of FIG. 13. FIG. 14 is a diagram showing a screen example having transited from the screen example of FIG. 13, and shows the behaviors, in which the player executes the predetermined starting operation (e.g., the push of the start feature button 6m) so that the new base game or free spin is started. In the screen example shown in FIG. 14, the individual display areas A to E have transited to the variable display state.

The main CPU 32 continues the variable display state shown in FIG. 14 for a predetermined time period, and stops the variable display.

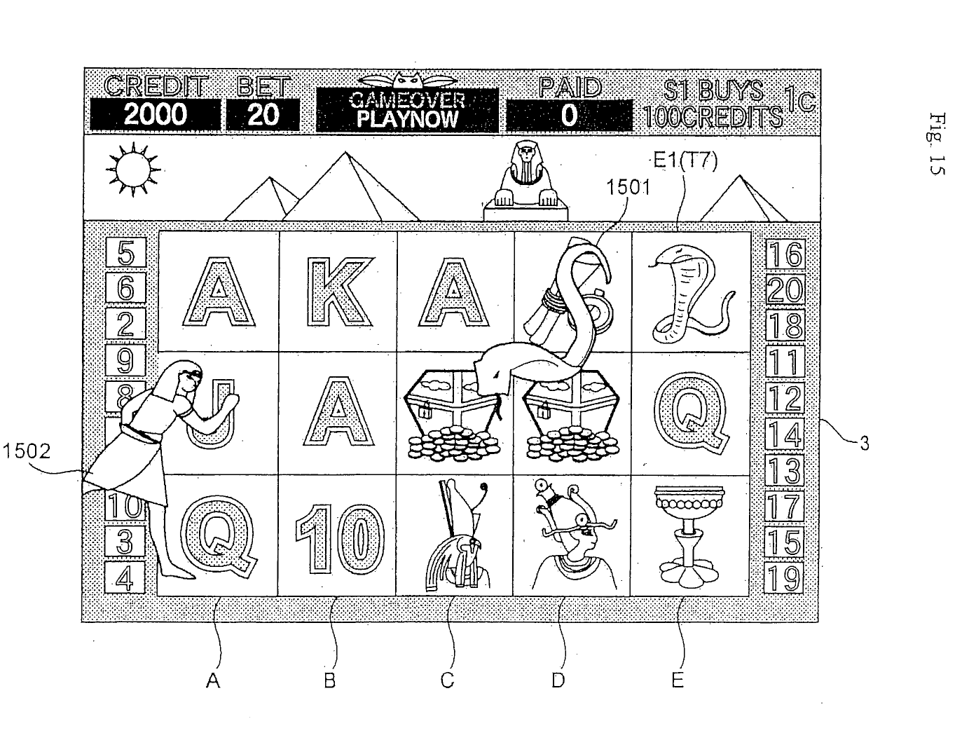

FIG. 15 is a diagram showing a screen example displayed in the display 3, and shows the behaviors, in which the variable display is stopped after the state of FIG. 14 so that the determined symbols are individually displayed in the individual symbol display areas A1 to A3, B1 to B3, C1 to C3, D1 to D3, and E1 to E3.

In the example shown in FIG. 15, there is satisfied the mystery feature game occurrence condition, that is, the event that the snake symbol T7 is displayed in the symbol display area E1. Therefore, the main CPU 32 starts the mystery feature game execution process (of Step S1202). In this example, the mystery feature game execution process includes an effect display process, a player interface process and a game result determination process.

In the example shown in FIG. 15, the effect display process is performed by the moving image display, in which a snake character 1501 relating to that symbol comes out of the snake symbol T7 displayed in the symbol display area E1, and in which a human character 502 implying the avatar of the player appears from the left side of the display area unit 81.

According to this slot machine 1, when a symbol of the snake character 1501 is displayed in the symbol display area E1, an effect can be made so that the player can recognize a change of the shift to the second special play mode of the mystery feature game state. Thus, the player is enabled to keep the interest in the play by expecting the appearance of that symbol.

While executing the effect display such as the moving image display in which the snake 501 based on the symbol relating to the mystery feature game occurrence condition comes out, the main CPU 32 executes the player interface process or the screen transition to the interface screen for causing the player to play the mystery feature game.

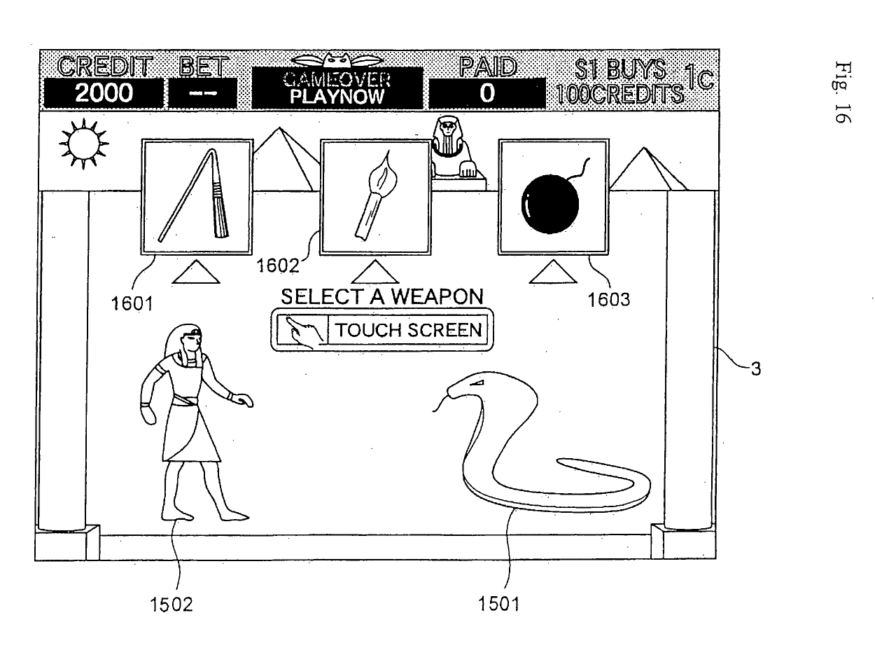

FIG. 16 is a diagram showing an example of the interface screen to be displayed after the image transition end or the result of the player interface process. In this example, the aforementioned snake character 1501 and human character 1502 are drawn to confront each other so that the battle between the characters is to start. At the same time, there are created select areas 1601, 1602 and 1603, in which the images (i.e., a frail, a torch and a bomb) of weapons to be selected by the player are displayed. In this example, the surface of the display 3 is provided with the not-shown touch panel sensors. When the player touches any of the select areas 1601, 1602 and 1603 with his or her finger, the main CPU 32 can recognize what select area has been selected by the player from the detection signal from the touch panel sensor.

During the player interface process, the main CPU 32 decides and stores the number of coins/credits to be paid out to the player in case the player selects the individual select areas 1601, 1602 and 1603. In this example, it is assumed that the numbers of coins/credits to be paid are decided at “30” for the select area 1601, “20” for the select area 1602 and “50” for the select area 1603. At this time of the screen state, however, the main CPU 32 does not disclose the numbers of coins/credits to be paid, to the player.

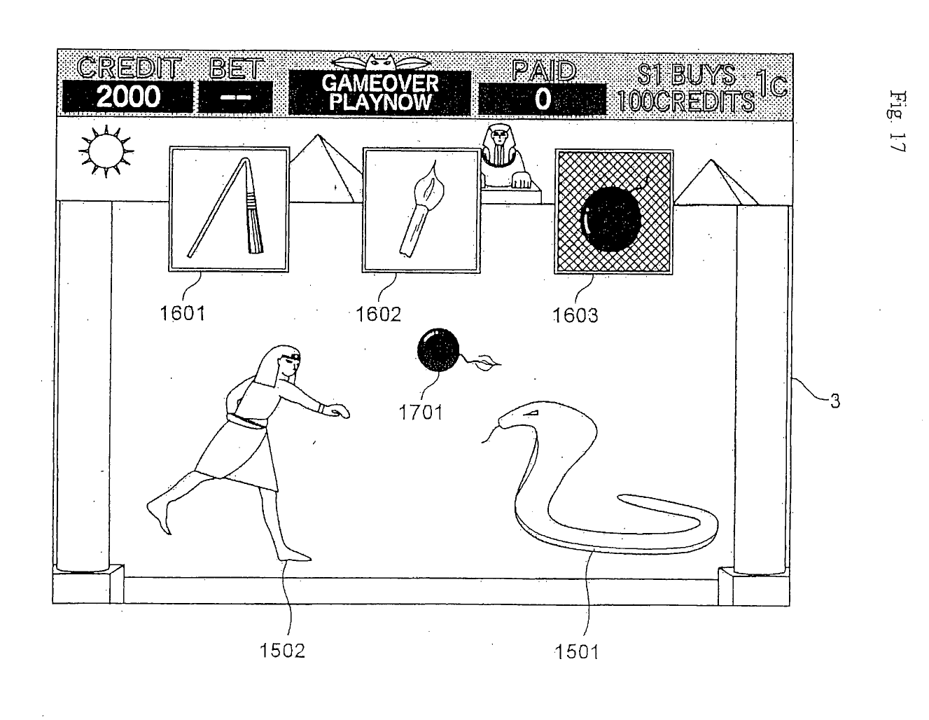

It is assumed in this example that the player touches the select area 1603 at the right end of the display 3 so as to select the bomb as the weapon. FIG. 17 is a diagram showing an example of the screen displayed on the display 3. This is an example of the effect screen which is displayed as a result that the main CPU 32 recognizes that the select area 1603 has been selected by the player with the detection signal from the (not-shown) touch panel sensor.

In this example, the main CPU 32 performs, as the effects of the mystery feature game, the moving image display, in which a bomb 1701 or the weapon corresponding to the select area 1603 selected by the player is thrown toward the snake character 1501 by the human character 1502.

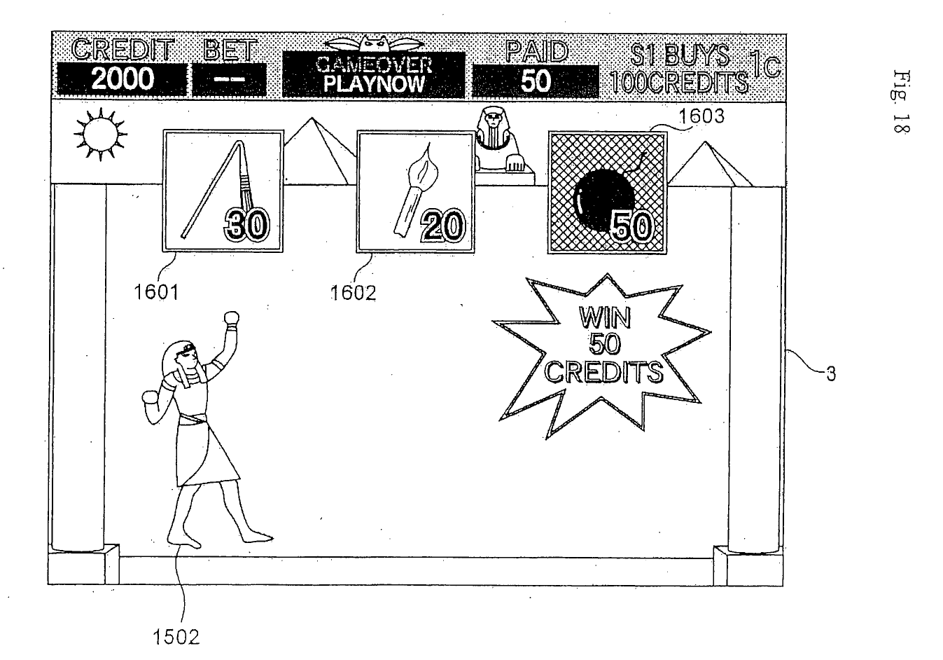

Subsequent to the screen shown in FIG. 17, the main CPU 32 executes the game result determination process to display the result of the mystery feature game. FIG. 18 is a screen example, as displayed by the game result determination process, of the result of the mystery feature game. In this screen example, there is displayed the situation, in which the human character 1502 has won in the battle so that a snake character 1401 has disappeared. It is informed to the player by displaying the individual numerical values in the select areas that the number “30”, the number “20” and the number “50” are assigned as the numbers of coins/credits to be paid to the select area 1601, the select area 1602 and the select area 1603, respectively. From these numerical values, the player judges the skill of his or her selections.

In this example, it is assumed that the battle between the human character 1502 and the snake character 1501 always results in the victory of the human character 1502 so that the player can acquire 20 to 50 coins/credits without fail. In the invention, however, the contents of the mystery feature game need not always be limited to that setting. The result of the battle between the human character 1502 and the snake character 1501 may be so determined by a random number that the human character 1502 may lose the battle as the case may be. In case the human character 1502 is defeated, the mystery feature game may also be modified such that the player cannot acquire the numbers of coins/credits.

The description of the mystery feature game process is continued by reverting to FIG. 12. After the aforementioned screen displays to FIG. 18, the mystery feature game execution process (of Step S1202) is ended. After this, the main CPU 32 performs an acquired coin paying process (of Step S1203) to instruct the hopper drive circuit 63 to eject the numbers of coins/credits determined according to the result of the mystery feature game execution process, to the hopper drive circuit 63.

The mystery feature game process is thus ended, and the main CPU 32 returns the control to the initial process or the main process (of FIG. 9). The description of the mystery feature game process is thus ended, and the description of the main process is continued by reverting to FIG. 9.

When the mystery feature game process (of Step S906) is ended, the main process returns again to the start acceptance process (of Step S901). After this, the operations of Step S901 to Step S906 are circularly repeated.

The descriptions of the main process and the first embodiment are ended.

### 2. Second Embodiment

Here is described a slot machine according to a second embodiment of the invention.

The slot machine according to the second embodiment is similar in its configuration and appearance to the slot machine 1 according to the first embodiment and is also similar in its actions (i.e., the main process, the feature game process and the mystery feature game process) to the slot machine 1 according to the first embodiment so that its detailed description is omitted.

The aforementioned slot machine according to the first embodiment is characterized in that the microcomputer 31 (or the main CPU 32) or the determination means decides not only the feature game occurrence condition or the first special play mode but also the mystery feature game occurrence condition or the second special play mode on the basis of the symbols which are displayed in the display areas A to E in the state of the stopped variable display.

On the contrary, the slot machine 1 according to the second embodiment of the invention is characterized in that the mystery feature game occurrence condition or the second special play mode is decided with the information independent of the symbols displayed in the display areas A to E in the stopped variable display state or the basis for determining the feature game occurrence condition, although the feature game occurrence condition or the first special play mode is decided like the first embodiment on the basis of the symbols displayed in the display areas A to E in the stopped variable display state.

The “information independent of the symbols displayed in the display areas A to E” is the information capable of determining the mystery feature game occurrence condition, irrespective of the symbols displayed in the display areas A to E, and the random number which is extracted by using the random number generator 35 and the sampling circuit 36, for example. The mystery feature game is raised when the lottery wins with that random number.

In the slot machine 1 according to the second embodiment, the main CPU 32 functions as the first determination means for determining the occurrence condition of the feature game or the first special play mode. On the other hand, the main CPU 32 also functions as the second determination means for determining the occurrence condition of the mystery feature game. The second determination means is characterized by performing the determination independently of the first determination means, and the determination result of the second determination means has neither influence on nor relation to the determination result of the first determination means.

The main CPU 32 or the second determination means decides the mystery feature game occurrence condition on the basis of the information independent of the symbols displayed in the display areas A to E. In the slot machine 1 according to the second embodiment, therefore, the shift to the mystery feature game occurs independently of the symbols displayed in the stopped variable display state. Therefore, the player can feel that the shift to the mystery feature game occurs at random. The player is always enabled to have an expectation for the shift to the mystery feature game and accordingly to enjoy the play without feeling the monotonousness of the play.

In case the random number extracted by using the random number generator 35 and the sampling circuit 36 is used as the “information independent of the symbols displayed in the display areas A to E”, an arbitrary timing such as the starting or ending time of the base game or the starting or ending time of the free spin can be adopted as the random number extracting timing.

In the description thus far made, moreover, the first determination means and the second determination means are realized by the main CPU 32 or the common hardware but need not always be realized by the common hardware, but the configuration may be modified such that a CPU other than the main CPU 32 is provided as the second determination means.

### 3. Modification

The invention should not be limited to the embodiments thus far described but can be modified in various manners. These modifications of the invention are exemplified in the following.

(1) In the foregoing embodiments, the slot machine 1 has been described as the slot machine having a video type reel. However, the invention can also be embodied by a slot machine having a mechanical reel.

(2) The foregoing embodiments have been described on the configuration, in which the number of the display areas of the display 3 corresponding to the reel number of the slot machine is 5. However, the number of the reel number/the display areas in the invention should not be limited to 5 but may be increased/decreased, if necessary, to 3 or 9.

(3) The foregoing embodiments have been described such that the first special play mode and the second special play mode are the different games (i.e., the feature game and the mystery feature game). However, the invention can also be embodied such that the first special play mode and the second special play mode are identical games. For example, the mystery feature game should not be limited to the game having the contents, as shown in FIG. 13 to FIG. 18, but may also be game having ten free spins.

Although the present invention has been explained in reference to the embodiment(s), it is apparent for those skilled in the art that many changes and modifications can be made without departing from the spirit and scope of the invention, as clear from the following claims.

What is claimed is:

1. A gaming machine comprising:
a symbol display device including a plurality of symbol display units capable of variably displaying a plurality of symbols, for displaying at least one of the plurality of symbols in each of the symbol display units when the variable display is stopped according to a predetermined stop condition; and
a determination device
for determining whether or not the symbols stopped and displayed in each of the symbol display units contain a first predetermined symbol combination disclosed to a player, to pay out valuables to the player, in case the symbols contain the first predetermined symbol combination, and
for determining whether or not the symbols stopped and displayed in each of the symbol display units contain a second predetermined symbol combination disclosed to the player, to Shift the play mode from a base play mode to a first special play mode for making the payout of the valuables beneficial to the player, in case the symbols contain the second predetermined symbol combination,
wherein the determination device shifts the play mode from the base play mode to a second special play mode, in which the payout of the valuables is made beneficial to the player, when the symbols contain neither the first predetermined symbol combination nor the second predetermined symbol combination, in case the symbols stopped and displayed in each of the symbol display units contain a third predetermined symbol combination not disclosed to the player, and in case a predetermined condition is satisfied.

2. A gaming machine according to claim 1,
wherein the predetermined condition is that the third predetermined symbol combination is displayed on an activated line.

3. A gaming machine according to claim 1,
wherein an effect using at least one of the symbols contained in the third predetermined symbol combination is executed, in case the symbols contain the third predetermined symbols and in case the predetermined condition is satisfied, when the determination device shifts the play mode from the base play mode to the second special play mode, in which the payout of the valuables is made beneficial to the player.

4. A gaming machine comprising:
a symbol display device including a plurality of symbol display units capable of variably displaying a plurality of symbols, for displaying at least one of the plurality of symbols in each of the symbol display units when the variable display is stopped according to a predetermined stop condition;
a first determination device
for determining whether or not the symbols stopped and displayed in each of the symbol display units contain a first predetermined symbol combination, to pay out valuables to a player in case the symbols contain the first predetermined symbol combination, and
for determining whether or not the symbols stopped and displayed in each of the symbol display units contain a second predetermined symbol combination, to shift the play mode from a base play mode to a first special play mode for making the payout of the valuables beneficial to the player, in case the symbols contain the second predetermined symbol combination; and
a second determination device for shifting the play mode from the base play mode to a second special play mode, in which the payout of the valuables is made beneficial to the player, in response to the satisfaction of a predetermined play mode occurrence condition.

5. A gaming machine according to claim 4,
wherein the predetermined play mode occurrence condition is to win in a random number lottery.
